(19) United States
(12) Patent Application Publication
(10) Pub. No.: US 2008/0065667 A1
(43) Pub. Date: Mar. 13, 2008

(54) Transaction oriented resilient file system

(76) Inventor: Donald F. Hopkins, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/518,652

(22) Filed: Sep. 11, 2006

(51) Int. Cl. G06F 7/00

(52) U.S. Cl. 707/101

(57) ABSTRACT

In one embodiment a computer system, comprises one or more processors a memory module communicatively connected to the one or more processors and comprising logic instructions which, when executed on the one or more processors configure the one or more processors to receive, in a file system, a file creation instruction to create a first version of a file, create, in the file system, a first virtual block table for the first file version identified in the file creation instruction, map the first virtual block table to one or more blocks of storage on physical media, record a file identifier for the first file version in a directory entry maintained by the file system, associate the first virtual block table with the file identifier in the directory entry, and associate a transaction identifier with the first file version in the directory.

### TECHNICAL FIELD

This application relates to electronic computing, and more particularly to transaction oriented file systems.

### BACKGROUND

Some operating systems require one or more sets of configuration files to be in a consistent state in order to boot successfully. For example, in some UNIX operating systems a set of configuration files may define a particular system configuration which is managed by a set of kernel configuration tools. The configuration files need to be consistent for the system configuration to function correctly and for the system to boot correctly.

If one of the files in the file set becomes damaged or if computer operations terminate in a manner that leaves the file set in an inconsistent state, then the file set may not be available to reboot the computer system in a desired configuration. In some instances a set of configuration files that has been previously stored may be used to boot the computer. In other instances the system may need to be completely reinstalled.

Thus, careful management of file sets such as, e.g., configuration file sets, may facilitate efficient utilization of computer resources.

### SUMMARY

In one embodiment a computer system, comprises one or more processors a memory module communicatively connected to the one or more processors and comprising logic instructions which, when executed on the one or more processors configure the one or more processors to receive, in a file system, a file creation instruction to create a first file version, create, in the file system, a first virtual block table for the first file version identified in the file creation instruction, map the first virtual block table to one or more blocks of storage on physical media, record a file identifier for the first file version in a directory entry maintained by the file system, associate the first virtual block table with the file identifier in the directory entry, and associate a transaction identifier with the first file version in the directory entry.

### BRIEF DESCRIPTION OF THE DRAWINGS

FIG. 1 is a schematic illustration of one embodiment of a computing system adapted to implement a transaction oriented resilient file system.

FIG. 2 is a flowchart illustrating operations that may be implemented by a file system to create a file directory mapping structure for use in a transaction oriented resilient file system.

FIG. 3A is a schematic illustration of one embodiment of a file directory mapping structure that may be used to implement a transaction oriented resilient file system.

FIG. 3B is a schematic illustration of one embodiment of an amended file directory entry structure that may be used to implement a transaction oriented file system.

FIG. 4 is a flowchart illustrating operations that may be implemented by a file system to amend the file directory mapping structure depicted in FIG. 3A.

FIG. 5 is a schematic illustration of one embodiment of a transaction identifier record that may be used to implement a transaction oriented resilient file system.

FIG. 6 is a flowchart illustrating operations that may be used to implement a transaction oriented resilient file system.

FIG. 7 is a schematic illustration of transactions handled by file system 150.

FIG. 8 is a schematic illustration of an exemplary computing environment.

### DETAILED DESCRIPTION

Described herein are exemplary system and methods a transaction oriented resilient file system which may be used in a computer system. The methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

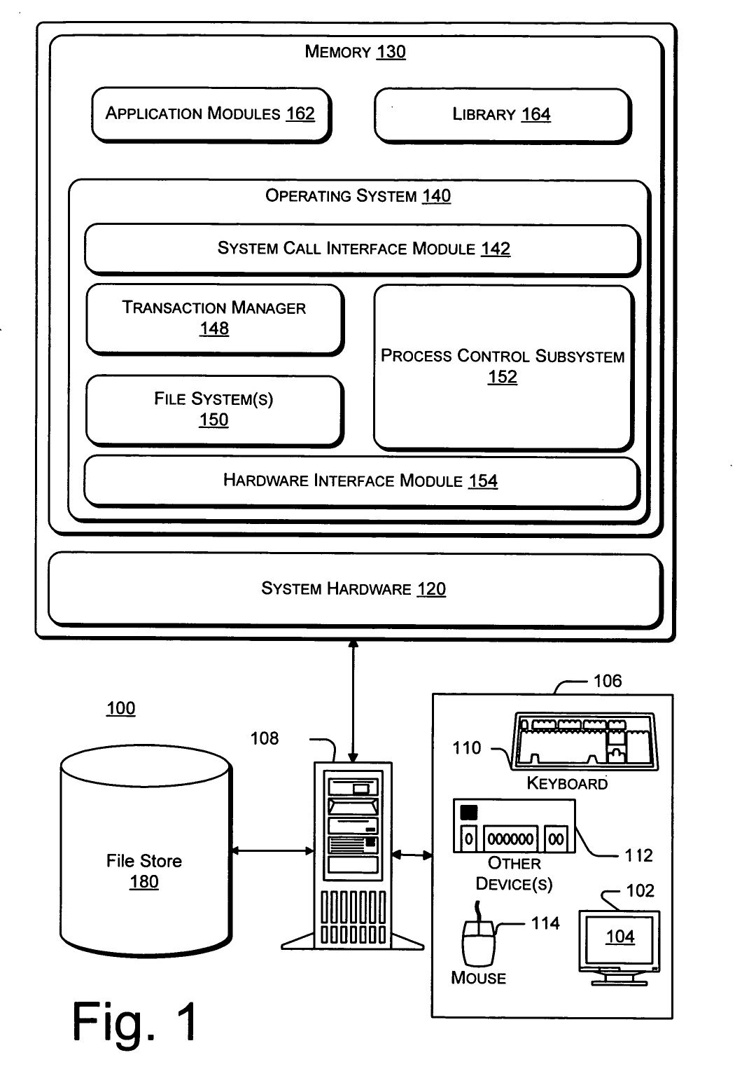

FIG. 1 is a schematic illustration of an exemplary computer system 100 adapted to implement a transaction based resilient file system. The computer system 100 includes a computer 108 and one or more accompanying input/output devices 106 including a display 102 having a screen 104, a keyboard 110, other I/O device(s) 112, and a mouse 114. The other device(s) 112 can include a touch screen, a voice-activated input device, a track ball, and any other device that allows the system 100 to receive input from a developer and/or a user. The computer 108 includes system hardware 120 and random access memory and/or read-only memory 130. A file store 180 is communicatively connected to computer 108. File store 180 may be internal such as, e.g., one or more hard drives, or external such as, e.g., one or more external hard drives, network attached storage, or a separate storage network.

Memory 130 includes an operating system 140 for managing operations of computer 108. In one embodiment, operating system 140 includes a hardware interface module 154 that provides an interface to system hardware 120. In addition, operating system 140 includes one or more file systems 150 that manage files used in the operation of computer 108 and a process control subsystem 152 that manages processes executing on computer 108. Operating system 140 further includes a system call interface module 142 that provides an interface between the operating system 140 and one or more application modules 162 and/or libraries 164.

In operation, one or more application modules 162 and/or libraries 164 executing on computer 108 make calls to the system call interface module 142 to execute one or more commands on the computer's processor. The system call interface module 142 invokes the services of the file system(s) 150A to manage the files required by the command(s) and the process control subsystem 152 to manage the process required by the command(s). The file system(s) 150 and the process control subsystem 152, in turn, invoke the services of the hardware interface module 154 to interface with the system hardware 120.

The particular embodiment of operating system 140 is not critical to the subject matter described herein. Operating system 140 may be embodied as a UNIX operating system or any derivative thereof (e.g., Linux, Solaris, etc.) or as a Windows® brand operating system.

In one embodiment, computer system 100 includes a transaction manager 148 which cooperates with the file system(s) 150 to implement a transaction oriented resilient file system. For example, one or more files may be grouped into a file set, and changes to the files in the file set may be permitted on a transaction oriented basis, such that if the all file changes specified in a particular transaction cannot be completed, then none of the file changes in the transaction will be implemented. The transaction manager 148 includes logic to manage transaction groups and utilizes the services of file system 150 to keep implement a transaction oriented resilient file system. The structure and operations of transaction manager 148 and file system 150 are described in greater detail below.

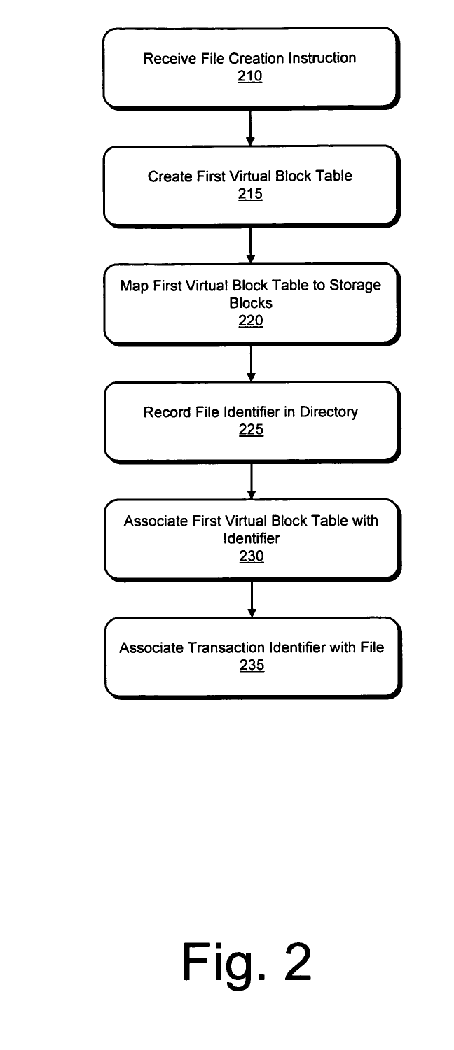

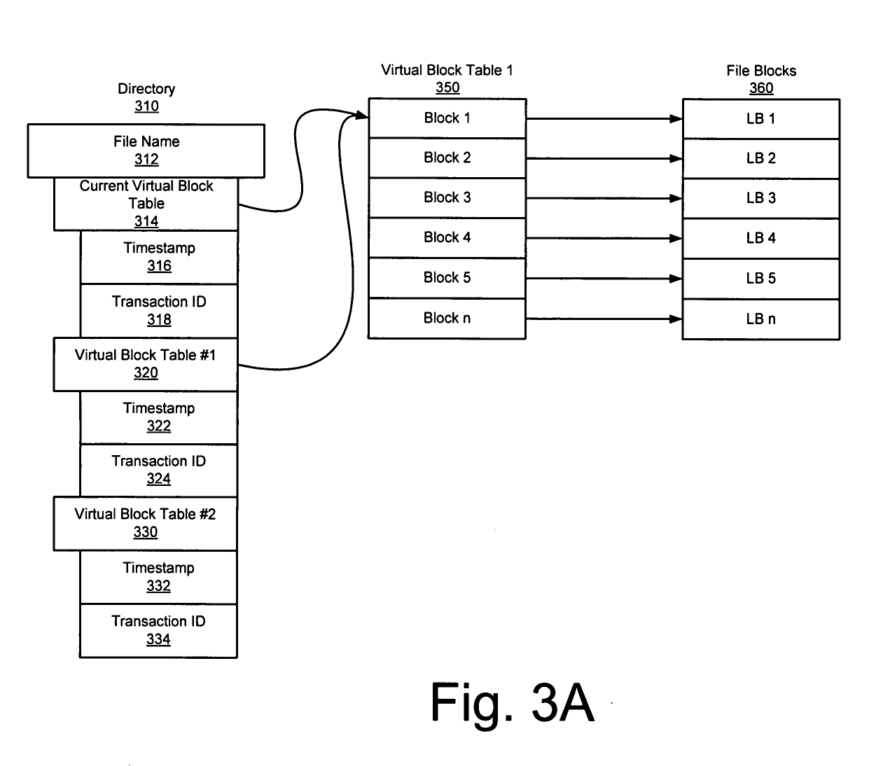

FIG. 2 is a flowchart illustrating operations that may be implemented by a file system to create a file directory mapping structure for use in a transaction oriented file system. FIG. 3A is a schematic illustration of one embodiment of a file directory mapping structure that may be used to implement a transaction oriented file system. File creation processes implemented by file system 150 will be explained with reference to FIG. 2 and FIG. 3A.

Referring to FIG. 3A, file system 150 may implement a directory entry structure 310 that includes fields that contain information on the file(s) stored on the physical media and on changes to the files. File system 150 may further implement one or more virtual block tables 350, 352, which map to file blocks 360, 362 on physical media on which file blocks are stored. The directory entry 310 may include entries for file(s) managed by the file system 150. The directory entry 310 depicted in FIG. 3 illustrates an entry for a single file. In practice, the directory may include entries for a multiplicity of files.

Referring to FIG. 2, when, at operation 210, file system 150 receives a request to create a file, the file system 150 creates, at operation 215, a first virtual block table 350 for the file identified in the file creation request. The first virtual bock table 350 includes entries (e.g., pointers) that, at operation 215, are mapped to the logical (or physical) blocks 360 on the underlying storage media on which the file resides. When a file is created, there will typically be a direct mapping from the virtual block table 350 to the file blocks 360 that contain data for the file.

At operation 225 the file system 150 further records a file name entry 312 in the directory entry 310. At operation 230 the file system 150 associates the first virtual block table 350 with the file identifier and creates an entry that defines a logical association between the directory entry 310 and the first virtual block table 350. For example, the file system 150 may make a virtual block table entry 320 in directory entry 310 that points to the first virtual block table 350. At operation 235 the file system 150 associates a transaction identifier with the file. For example, a transaction identifier 324 may be entered into the directory entry 310 associated with virtual block table 1 entry 320. A timestamp 322 that indicates a time at which virtual block table 1 350 was created may also be entered into directory entry 310 associated with virtual block table 1 entry 320.

The directory entry structure 310 implemented by the file system 150 to facilitate a transaction oriented file system may include entries for a plurality of virtual block tables. The directory entry 310 depicted in FIG. 3b includes entries for two virtual block tables. In alternate embodiments, the directory 310 may include entries for more virtual block tables. Additional virtual block tables represent additional versions of the file. In addition, directory 310 includes entries for the current virtual block table.

When a file is created only a single virtual block table is required. Hence, the currently virtual block table entry 314 may be associated with virtual block table 1 250. Similarly, timestamp 316 and transaction identifier 318 may be associated with the file creation timestamp and transaction identifier.

A file managed by file system 150 may be updated, for example, by a write or other I/O operation generated by an application module 162 executing on computing system 100. Rather than overwriting the file block(s) that contain the data affected by the I/O operation, the file system 150 creates or reuses another virtual block table 350 to accommodate changes to the data blocks updated by the I/O operation.

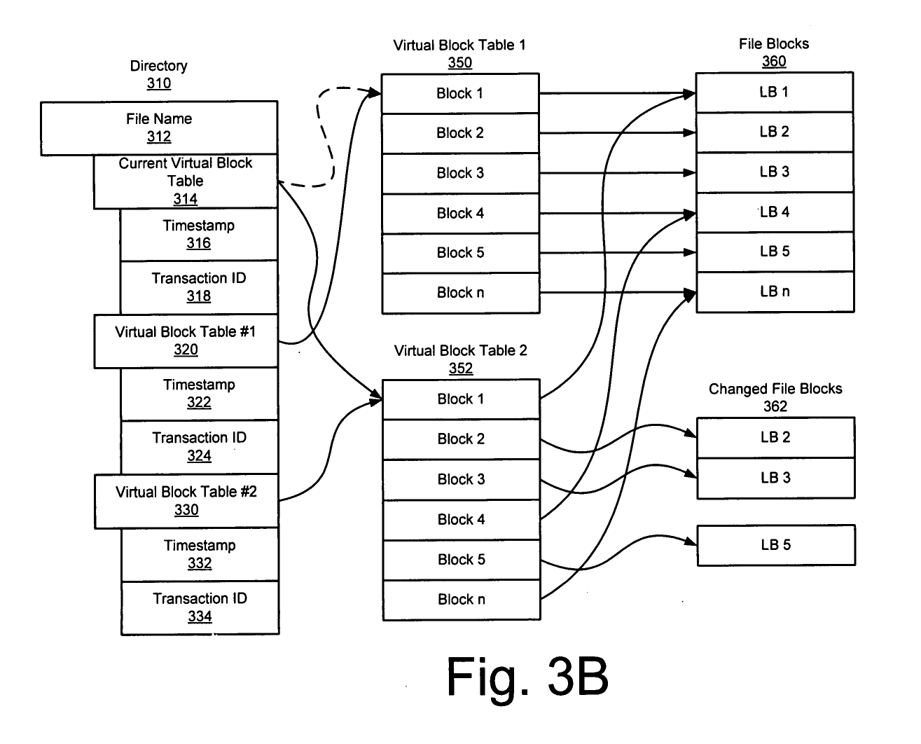

FIG. 4 is a flowchart illustrating operations that may be implemented by a file system to amend the file directory mapping structure depicted in FIG. 3A. FIG. 3B is a schematic illustration of one embodiment of an amended file directory entry structure that may be used to implement a transaction oriented file system. File modification processes implemented by file system 150 will be explained with reference to FIG. 4 and FIG. 3B.

Referring to FIG. 4, at operation 410 the file system 150 receives a file update request. The file update request may originate with an application 162 executing on computing system 100. Alternatively, the file update request may originate with an application executing on a remote computing device coupled to computing system 100. The file update request may include, for example, a write operation or a copy operation.

At operation 415 it is determined whether the directory entry structure 310 has capacity to add an additional virtual block table. In theory, directory structure 310 may include an infinite number of virtual block tables. In practice, directory structure 310 may be limited to any number of virtual block tables greater than two (2). In the embodiment depicted in FIG. 3B, the directory entry 310 includes two virtual block tables.

If, at operation 415, the directory entry structure 310 includes an unallocated virtual block table, then control passes to operation 420 and the file system 150 creates a new virtual block table. Referring to FIG. 3B, the new virtual block table corresponds to virtual block table 2 352. In one embodiment, the new virtual block table may be created as a copy of the current virtual block table. Thus, in the embodiment depicted in FIG. 3B, virtual block table 2 may be created as a copy of virtual block table 1. At operation 425 the new virtual block table is associated with the file identifier.

By contrast, if at operation 415 the directory entry structure 310 does not include an unallocated virtual block table, then control passes to operation 430 and the file system 150 recycles the oldest virtual block table. In one embodiment, the contents of the current virtual block table are copied to the new current virtual block table. In the embodiment depicted in FIG. 3B in which the directory entry structure 310 is configured to include two virtual block tables, the virtual block tables essentially alternate positions as the current virtual block table. For example, the file system 150 may alternate the current virtual block table pointer 314 between the first virtual block table 350 and the second virtual block table 352. Thus, at operation 435 the current virtual block table pointer 314 is reset.

At operation 440 the changes to the file data are recorded in separate file block designated as changed file blocks 362 in FIG. 3B. At operation 445 the blocks of the file(s) affected by the file update request are mapped to the storage blocks that contain the new data. For example, in the embodiment depicted in FIG. 3B, the file updates affect logical blocks LB2, LB3, and LB5. Thus, the pointers in virtual block table 2 352 for these blocks are set to point to the changed file blocks 362.

Thus, file system 150 provides the ability to update files managed by file system 150 without overwriting data in the files. In addition, file system 150 permits the computing system 100 to maintain multiple versions of files without reproducing the all the data in the file.

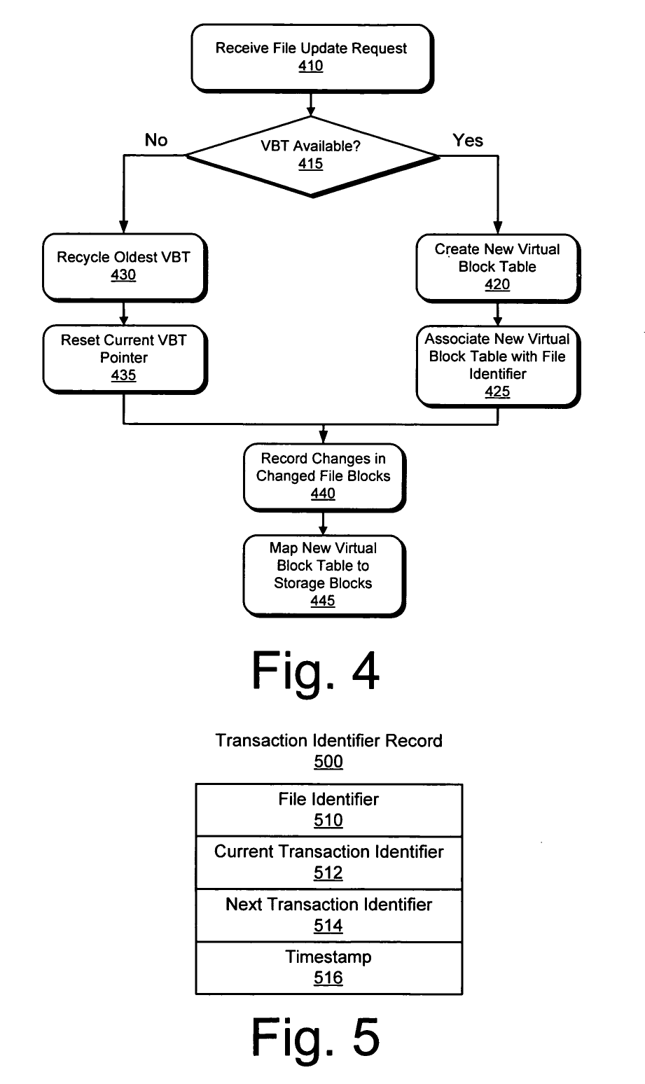

In some embodiments a transaction identifier record is associated with each file managed by file system 150. In some embodiments the file system 150 may maintain the transaction identifier records. In alternate embodiment the transaction manager 148 may maintain the transaction identifier records. FIG. 5 is a schematic illustration of one embodiment of a transaction identifier record 500 that may be used to implement a transaction oriented file system. Referring to FIG. 5, in one embodiment the transaction identifier record 500 include a file identifier 510, a current transaction identifier 512, a next transaction identifier 514, and a timestamp 516.

The file identifier 510 may be embodied as a file name, or any other identifier that uniquely identifies a file managed by file system 150. The transaction identifiers 512, 514 may be embodied as, e.g., sequential numerals or characters that uniquely identify a transaction. The current transaction identifier 512 may contain the identifier of the most recently completed successful transaction. The next transaction identifier may contain the next sequence in the transaction numerals or characters. For example, in an embodiment in which transactions are identified with sequential integers such as, e.g., 1, 2, 3 . . . n, the current transaction identifier is incremented to obtain the next transaction identifier. In addition, the transaction identifier record 500 may include a timestamp 516.

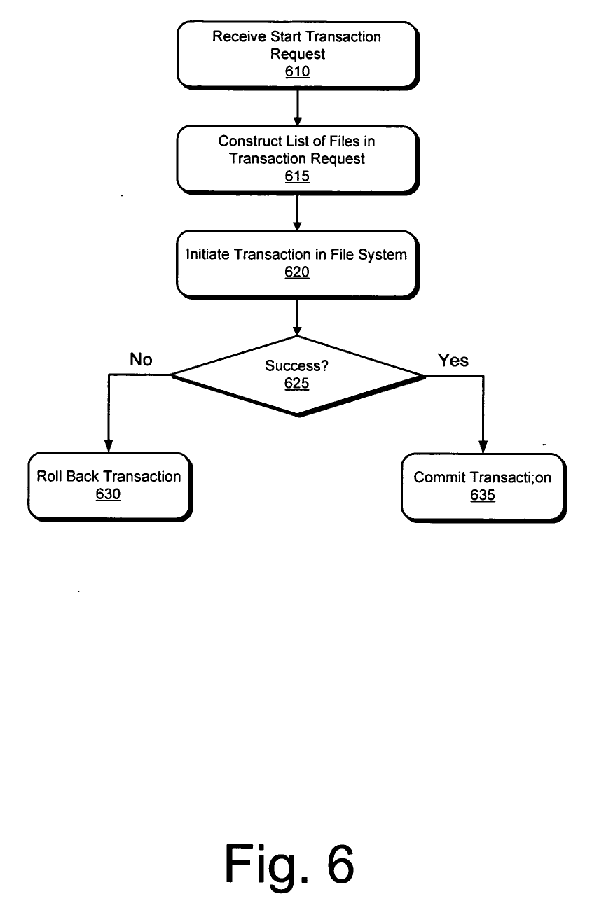

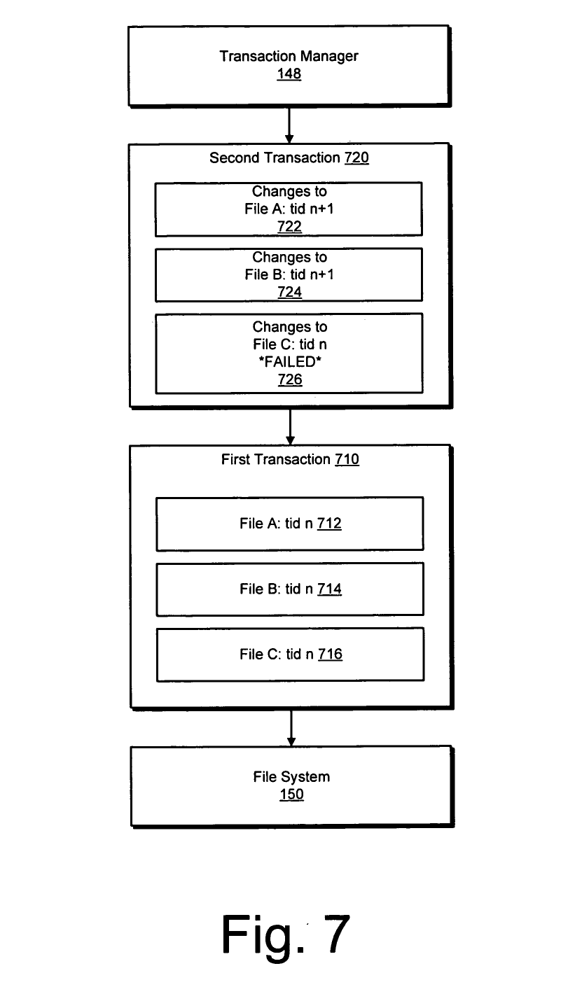

In some embodiments the transaction manager 148 alone or in combination with the file system 150 may use the transaction identifier record 500 to implement a transaction oriented file system. FIG. 6 is a flowchart illustrating operations that may be used to implement a transaction oriented file system. FIG. 7 is a schematic illustration of transactions handled by file system 150.

Referring to FIG. 6, at operation 610 a start transaction request is received. For example, referring to FIG. 7, an application executing on computer system 100 may generate a first transaction 710. The first transaction 710 may include a change request for file A 712, a change request for file B 714 and a change request for file C 716. In one embodiment, the transaction request may be received in the transaction manager 148, which assigns a transaction identifier (n) to the transaction.

At operation 615 the transaction manager 148 constructs a list of files in the transaction request. At operation 620 the transaction manager 148 initiates a transaction in the file system 150. For example, the transaction manager may invoke the process illustrated in FIG. 4. If, at operation 625 the transaction was unsuccessful, then control passes to operation 630 and the transaction is rolled back, such that none of the changes are committed. By contrast, if at operation 625 the transaction was successful, then control passes to operation 635 and the changes implemented in the transaction are committed.

In one embodiment a transaction may be considered successful if all file update requests in the transaction are completed successfully. If one file update request fails, then the entire transaction is considered unsuccessful. This enables transactions to be handled in an atomic fashion.

In one embodiment the transaction identifier record may be used to roll back a transaction (operation 630) or to commit a transaction (operation 635). When a transaction is successfully completed the current transaction identifier 512 will be incremented. At this point in time the current transaction identifier 512, the next transaction identifier 514 and the transaction identifier 318 in the directory entry 310 for all files updated will have the same value. These values may then be used during the boot process, mount time or any time the file is accessed to ensure file system consistency. By contrast, if a transaction is unsuccessful, then the current transaction identifier 512 is not incremented, the virtual block table 350 and file block data 360 for the failed transaction file set is removed or marked inactive.

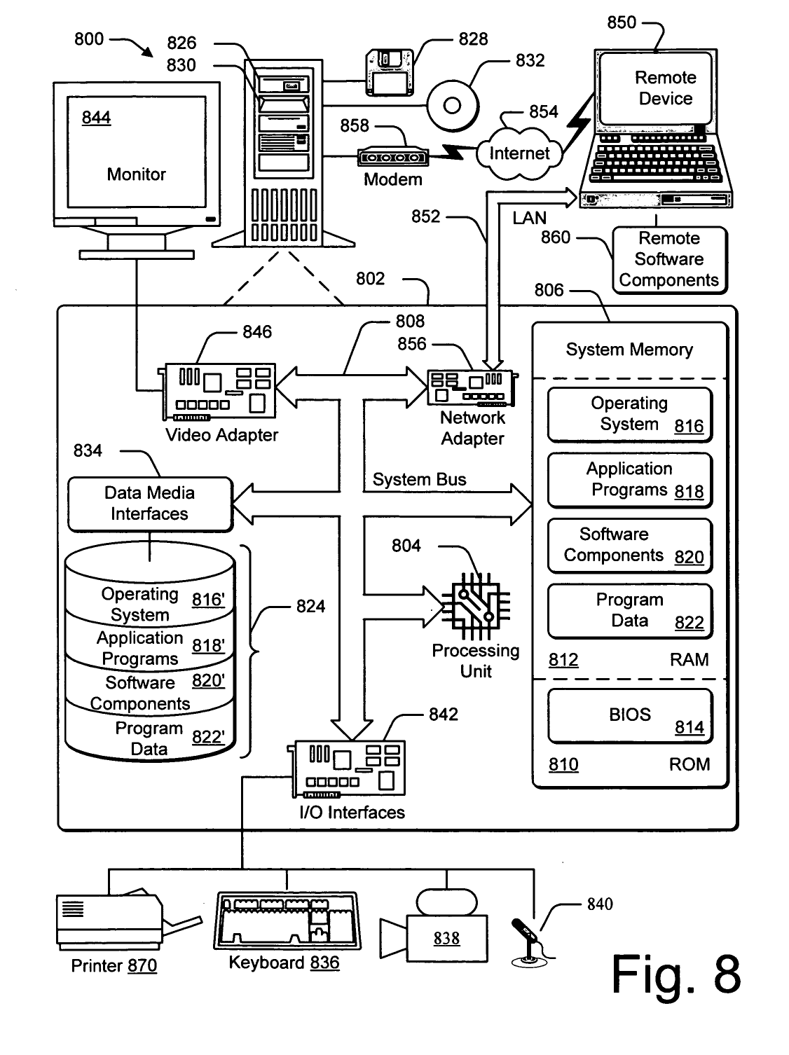

Embodiments discussed herein may be embodied in machine-executable instructions, which may in turn be utilized to cause a general-purpose or special-purpose processor, or logic circuits programmed with the instructions to perform the operations. Alternatively, the operations may be performed by a combination of hardware and software. Various components and functionality described herein may be implemented within one or more computers. FIG. 5 shows components of typical example of such a computer, referred by to reference numeral 800. The components shown in FIG. 8 are only examples, and are not intended to suggest any limitation as to the scope of the functionality of the invention; the invention is not necessarily dependent on the features shown in FIG. 8.

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The functionality of the computers is embodied in many cases by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions, programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 8, the components of computer 800 may include, but are not limited to, a processing unit 804, a system memory 806, and a system bus 808 that couples various system components including the system memory 806 to the processing unit 804. The system bus 808 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as the Mezzanine bus.

Computer 800 typically includes a variety of computer-readable media. Computer-readable media can be any available media that can be accessed by computer 800 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 800. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network, fiber optic networks, or direct-wired connection and wireless media such as acoustic, RF, infrared and other wireless media. Combinations of any of the above should also be included within the scope of computer readable media.

The system memory 806 includes computer storage media in the form of volatile and/or nonvolatile memory such as read only memory (ROM) 810 and random access memory (RAM) 812. A basic input/output system 814 (BIOS), containing the basic routines that help to transfer information between elements within computer 800, such as during start-up, is typically stored in ROM 810. RAM 812 typically contains data and/or program modules that are immediately accessible to and/or presently being operated on by processing unit 804. By way of example, and not limitation, FIG. 8 illustrates operating system 816, application programs 818, other software components 820, and program data 822.

The computer 800 may also include other removable/non-removable, volatile/nonvolatile computer storage media. By way of example only, the computer system of FIG. 8 may include a hard disk drive 824 that reads from or writes to non-removable, nonvolatile magnetic media, a magnetic disk drive 826 that reads from or writes to a removable, nonvolatile magnetic disk 828, and an optical disk drive 830 that reads from or writes to a removable, nonvolatile optical disk 832 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 824 is typically connected to the system bus 808 through a non-removable memory interface such as data media interface 834, and magnetic disk drive 826 and optical disk drive 830 are typically connected to the system bus 808 by a removable memory interface.

The drives and their associated computer storage media discussed above and illustrated in FIG. 8 provide storage of computer-readable instructions, data structures, program modules, and other data for computer 800. In FIG. 8, for example, hard disk drive 824 is illustrated as storing operating system 816′, application programs 818′, software components 820′, and program data 822′. Note that these components can either be the same as or different from operating system 816, application programs 818, software components 820, and program data 822. Operating system 816, application programs 818, other program modules 820, and program data 822 are given different numbers here to illustrate that, at a minimum, they are different copies. A user may enter commands and information into the computer 800 through input devices such as a keyboard 836 and pointing device 838, commonly referred to as a mouse, trackball, or touch pad. Other input devices (not shown) may include a microphone 840, joystick, game pad, satellite dish, scanner, or the like. These and other input devices are often connected to the processing unit 804 through an input/output (I/O) interface 842 that is coupled to the system bus, but may be connected by other interface and bus structures, such as a parallel port, game port, or a universal serial bus (USB). A monitor 844 or other type of display device is also connected to the system bus 806 via an interface, such as a video adapter 846. In addition to the monitor 844, computers may also include other peripheral output devices (e.g., speakers) and one or more printers 870, which may be connected through the I/O interface 842.

The computer may operate in a networked environment using logical connections to one or more remote computers, such as a remote computing device 850. The remote computing device 850 may be a personal computer, a server, a router, a network PC, a peer device or other common network node, and typically includes many or all of the elements described above relative to computer 800. The logical connections depicted in FIG. 8 include a local area network (LAN) 852 and a wide area network (WAN) 854. Although the WAN 854 shown in FIG. 8 is the Internet, the WAN 584 may also include other networks. Such networking environments are commonplace in offices, enterprise-wide computer networks, intranets, and the like.

When used in a LAN networking environment, the computer 800 is connected to the LAN 852 through a network interface or adapter 856. When used in a WAN networking environment, the computer 800 typically includes a modem 858 or other means for establishing communications over the Internet 854. The modem 858, which may be internal or external, may be connected to the system bus 808 via the I/O interface 842, or other appropriate mechanism. In a networked environment, program modules depicted relative to the computer 800, or portions thereof, may be stored in the remote computing device 850. By way of example, and not limitation, FIG. 8 illustrates remote application programs 860 as residing on remote computing device 850. It will be appreciated that the network connections shown are exemplary and other means of establishing a communications link between the computers may be used.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

What is claimed is:

1. A method, comprising:
receiving, in a file system, a file creation instruction to create a first file version;
creating, in the file system, a first virtual block table for the first file version identified in the file creation instruction;
mapping the first virtual block table to one or more blocks of storage on physical media;
recording a file identifier for the first file version in a directory entry maintained by the file system;
associating the first virtual block table with the file identifier in the directory entry; and
associating a transaction identifier with the first file version in the directory entry.

2. The method of claim 1, further comprising:
creating a transaction identifier file for the first file version; and
assigning a current transaction identifier to the first file version.

3. The method of claim 2, further comprising:
receiving, in a transaction manager module a start transaction request identifying a set of files;
opening a transaction record in response to the request;
receiving, in the transaction manager, a request to update the transaction file set; and
initiating a request to the file system to update the transaction file set.

4. The method of claim 3, further comprising:
receiving, in the file system, the request to update the first file version;
creating, in the file system, a second virtual block table for the first file version identified in the file creation instruction, wherein the second virtual block table is a copy of the first virtual block table;
associating the second virtual block table with the file identifier in the directory entry;
recording changes to one or more blocks in the first file version in one or more new file blocks on physical media;
associating the changed file blocks with entries in the second virtual block table.

5. The method of claim 4, further comprising:
receiving, in the transaction manager, an end transaction request identifying a set of files including the transaction file set;
closing the transaction record in response to the request; and
committing one or more changes made to the transaction file set.

6. The method of claim 4, further comprising:
receiving, in the transaction manager, a signal indicating that one or more updates in a transaction failed to execute; and
terminating all updates in the transaction without committing the changes to the files.

7. The method of claim 5, wherein committing one or more changes made to a particular file comprises updating a transaction identifier associated with those particular files

8. A computer system, comprising:
one or more processors;
a memory module communicatively connected to the one or more processors and comprising logic instructions which, when executed on the one or more processors configure the one or more processors to:
receive, in a file system, a file creation instruction to create a first file version;
create, in the file system, a first virtual block table for the first file version identified in the file creation instruction;
map the first virtual block table to one or more blocks of storage on physical media;
record a file identifier for the first file in a directory entry maintained by the file system;
associate the first virtual block table with the file identifier in the directory entry; and
associate a transaction identifier with the first file in the directory entry.

9. The computer system of claim 8, wherein the memory module further comprises logic instructions which, when executed, configure the processor to:
create a transaction identifier file for the first file version; and
assign a current transaction identifier to the first file version.

10. The computer system of claim 8, wherein the memory module further comprises logic instructions which, when executed, configure the processor to:
receive, in a transaction manager module a start transaction request identifying a set of particular files;
open a transaction record in response to the request;
receive, in the transaction manager, a request to update a set of particular files; and
initiate a request to the file system to update that particular set of files.

11. The computer system of claim 8, wherein the memory module further comprises logic instructions which, when executed, configure the processor to:
receive, in the file system, the request to update the first file version;
create, in the file system, a second virtual block table for the first file version identified in the file creation instruction, wherein the second virtual block table is a copy of the first virtual block table;
associate the second virtual block table with the file identifier in the directory entry;
record changes to one or more blocks in the first file version in one or more new file blocks on physical media;
associate the new file blocks with entries in the second virtual block table.

12. The computer system of claim 8, wherein the memory module further comprises logic instructions which, when executed, configure the processor to:
receive, in the transaction manager, an end transaction request identifying a set of files;
close the transaction record in response to the request; and
commit one or more changes made to the transaction file set.

13. The computer system of claim 8, wherein the memory module further comprises logic instructions which, when executed, configure the processor to:
receive, in the transaction manager, a signal indicating that one or more updates in a transaction failed to execute; and
terminate all updates in the transaction without committing the changes to the files.

14. The computer system of claim 8, wherein the memory module further comprises logic instructions which, when executed, configure the processor to update a transaction identifier associated with the transaction file set.

15. A computer program product stored on a computer-readable medium comprising logic instructions which, when executed on a processor, configure a processor to:
receive, in a file system, a file creation instruction to create a first file version;
create, in the file system, a first virtual block table for the first file version identified in the file creation instruction;
map the first virtual block table to one or more blocks of storage on physical media;
record a file identifier for the first file version in a directory entry maintained by the file system;
associate the first virtual block table with the file identifier in the directory entry; and
associate a transaction identifier with the first file in the directory entry.

16. The computer program product of claim 15, further comprises logic instructions which, when executed, configure a processor to:
create a transaction identifier file for the first file version; and
assign a current transaction identifier to the first file version.

17. The computer program product of claim 15, further comprises logic instructions which, when executed, configure a processor to:
receive, in a transaction manager module a start transaction request identifying a set of files;
open a transaction record in response to the request;
receive, in the transaction manager, a request to update a set of particular files; and
initiate a request to the file system to update a particular set of files.

18. The computer program product of claim 15, further comprises logic instructions which, when executed, configure a processor to:
receive, in the file system, the request to update the first file version;
create, in the file system, a second virtual block table for the first file version identified in the file creation instruction, wherein the second virtual block table is a copy of the first virtual block table;
associate the second virtual block table with the file identifier in the directory entry;
record changes to one or more blocks in the first file in one or more changed file blocks on physical media;
associate the changed file blocks with entries in the second virtual block table.

19. The computer program product of claim 15, further comprises logic instructions which, when executed, configure a processor to:
receive, in the transaction manager, an end transaction request identifying a set of files;
close the transaction record in response to the request; and
commit one or more changes made to the transaction file set.

20. The computer program product of claim 15, further comprises logic instructions which, when executed, configure a processor to:
receive, in the transaction manager, a signal indicating that one or more updates in a transaction failed to execute; and
terminate all updates in the transaction without committing the changes to the files.
